(19) United States
(12) Patent Application Publication
(10) Pub. No.: US 2026/0200735 A1
(43) Pub. Date: Jul. 16, 2026

(54) METHOD FOR PREPARING MANGANESE PHOSPHATE

(71) Applicants: BEIJING LINLI NEW ENERGY CO. LTD, Beijing (CN); LINLI NEW ENERGY TECHNOLOGY CO., LTD., Huanggang, Hubei (CN)

(72) Inventor: Xiaoling MA, Huanggang, Hubei (CN)

(21) Appl. No.: 19/136,136

(22) PCT Filed: Dec. 5, 2023
(86) PCT No.: PCT/CN2023/136300

§ 371 Date: Jun. 5, 2025

(30) Foreign Application Priority Data
Dec. 8, 2022 (CN) 202211568276.0
Dec. 13, 2022 (CN) 202211592560.1
Dec. 15, 2022 (CN) 202211609338.8

(51) Int. Cl. C01B 25/37; C01B 25/45; H01M 4/36; H01M 4/58; H01M 4/587

(52) U.S. Cl. CPC C01B 25/377; C01B 25/45; H01M 4/366; H01M 4/5825; H01M 4/587; C01P 2002/72; C01P 2004/03; C01P 2004/80; C01P 2006/40

(57) ABSTRACT

Manganese phosphate is prepared by reacting pyrophosphoric acid with an oxide containing tetravalent manganese, trivalent manganese, or divalent manganese to obtain a manganese pyrophosphate complex solution, followed by decomplexation to obtain a manganese phosphate precipitate. A carbon-coated lithium manganese iron phosphate material is prepared using manganese phosphate as a lithium battery material.

The present application claims priority to the prior Patent Application No. 202211568276.0 filed with the China National Intellectual Property Administration on Dec. 8, 2022 and entitled with “PREPARATION METHOD FOR MANGANESE PHOSPHATE”, Patent Application No. 202211592560.1 filed with the China National Intellectual Property Administration on Dec. 13, 2022 and entitled with “METHOD FOR PREPARING MANGANESE PHOSPHATE FROM DIVALENT MANGANESE”, and Patent Application No. 202211609338.8 filed with the China National Intellectual Property Administration on Dec. 15, 2022 and entitled with “METHOD FOR PREPARING MANGANESE PHOSPHATE FROM TETRAVALENT MANGANESE”, which are incorporated herein by reference in their entireties.

### TECHNICAL FIELD

The present disclosure relates to the field of preparation of inorganic materials and lithium battery materials, and particularly, to the preparation of manganese phosphate and/or lithium manganese iron phosphate.

### BACKGROUND

Manganese phosphate is a chemical starting material with wide applications, and is mainly used as a phosphating agent for steel products, especially for the phosphating treatment of large mechanical equipment. It plays a role in preventing rust and may also serve as a lubricant and a protective agent in the national defense industry. In recent years, manganese phosphate possesses important application prospects as a high-quality starting material for preparing the positive electrode material lithium manganese phosphate in lithium-ion batteries.

Existing preparation methods mainly include:
1) oxidation-precipitation method: see, for example, the methods disclosed in CN101673819A and CN105609765A, where, in an acidic system, soluble divalent manganese sources and phosphorus sources are used as starting materials, and an oxidant is added to prepare a manganese phosphate product. Such methods have the problem of introducing elements other than manganese and phosphorus, thereby resulting in a low purity of the prepared product that hardly meets the requirements for lithium-ion battery materials, or requiring more post-purification treatment procedures and even producing excessive waste water, waste gas, and waste residues during the manufacture. For example, in some methods, manganese nitrate is used as the manganese source in the reaction, and the oxidation of Mn²⁺ to Mn³⁺ is achieved by utilizing the strong oxidizing property of nitrate radical in acidic conditions. However, such methods have a remarkable drawback that the nitrate radical may be reduced to toxic gaseous NO₂ after oxidizing Mn²⁺ to Mn³⁺, whereas the use of MnSO₄ and MnCl₂ as the manganese source introduces other impurity ions while leading to a reduced yield.
2) Solvothermal synthesis method: see, for example, “Solvothermal Synthesis and Characterization of Novel Titanium Phosphate and Manganese Phosphate Crystals” [D]. Jilin University, 2003, where manganese phosphate with a layered structure formed by manganese oxide octahedron and an oxide of phosphorus is prepared by using various organic amines as structure-directing agents in an n-butanol system. When used for preparing manganese phosphate, the solvothermal synthesis method involves a reaction system with a complicated composition, leading to manganese phosphate products with complicated composition and structure and difficulties in mass production.
3) the reaction of potassium permanganate with concentrated phosphoric acid to give manganese phosphate: see, e.g., in CN112142028B, where the reaction equation is as follows: 3KMnO₄+4H₃PO₄═3MnPO₄·H₂O+K₃PO₄+3H₂O+3O₂↑. The method is disadvantageous in poor atom economy that produces potassium phosphate byproducts and oxygen. The generation of potassium phosphate byproducts requires processing of waste water and the byproducts and thus reduced cost-efficiency in practice, while the release of O₂ may pose combustion and explosion risks during the production. There is an urgent need in the art for a new and cost-efficient method for preparing manganese phosphate, especially, a method for preparing battery-grade manganese phosphate.

### SUMMARY

In a first aspect of the present disclosure, provided is a method for preparing manganese phosphate, comprising: contacting, in a solution at pH<7, pyrophosphate ion with trivalent manganese ion to form a manganese pyrophosphate complex solution, and decomplexing to give a manganese phosphate precipitate.

According to the present disclosure, the trivalent manganese ion may be derived from a trivalent manganese-containing oxide, such as dimanganese trioxide; the trivalent manganese ion may also be derived from a tetravalent manganese-containing oxide by reducing the tetravalent manganese-containing oxide to trivalent manganese ions with a reductant, wherein the tetravalent manganese-containing oxide is, for example, one of manganese dioxide and trimanganese tetraoxide, or a combination thereof; the trivalent manganese ions may also be derived from a divalent manganese-containing oxide by oxidizing the divalent manganese-containing oxide to trivalent manganese ions with an oxidant, wherein the divalent manganese-containing oxide is, for example, manganese monoxide (MnO) or trimanganese tetraoxide (Mn₃O₄).

According to the present disclosure, the reductant is selected from an inorganic reductant and/or an organic reductant with a standard electrode potential value of lower than +0.77; preferably, the reducing agent is hydrogen peroxide, a ferrous ion-containing salt including a ferrous inorganic acid salt and a ferrous organic acid salt, a stannous ion-containing salt including a stannous inorganic acid salt and a stannous organic acid salt, a cuprous ion-containing salt including a cuprous inorganic acid salt and a cuprous organic acid salt, a C₁₋₈ acid and a salt thereof, a C₁₋₈ alcohol, a C₁₋₈ aldehyde or a C₃₋₈ ketone, a monosaccharide, a disaccharide or an oligosaccharide; more preferably, the reductant is hydrogen peroxide, formaldehyde, formic acid, oxalic acid, citric acid, ascorbic acid, a ferrous inorganic acid salt, a ferrous organic acid salt, a stannous inorganic acid salt, or a stannous organic acid salt.

According to the present disclosure, the oxidant is selected from MnO₂, Mn₂₆, manganous acid, manganous anhydride (Mn₂O₅), manganic acid (H₂MnO₄), manganic anhydride (MnO₃), HMnO₄, and permanganic anhydride, or may be selected from an alkali metal or alkaline earth metal manganate or permanganate salt and the like. The alkali metal salt or the alkaline earth metal salt are selected from a salt of an alkali metal such as potassium, sodium and lithium, and a salt of an alkaline earth metal such as calcium, magnesium, barium and cesium. The alkali metal or alkaline earth metal manganate or permanganate salt may also be used as an oxidant, but may lead to the introduction of heteroions and thus require subsequent procedures to remove the heteroions, such as separation and removal from the product or starting material by solid-liquid separation. The oxidant is selected from one of MnO₂, Mn₂O₆, manganous acid, manganous anhydride, manganic acid, manganic anhydride, HMnO₄, permanganic anhydride and potassium permanganate, or a combination thereof; most preferably, the oxidant is MnO₂ or potassium permanganate.

According to the present disclosure, preferably, the method comprises, before the decomplexing step:
removing unreacted solids by solid-liquid separation, wherein the unreacted solids comprise impurities and/or the unreacted oxide of manganese.

According to the present disclosure, in some embodiments of the present disclosure, the method for preparing manganese phosphate comprises:
step S1: preparation of the complex solution: controlling the phosphorus-to-manganese ratio in starting materials at no less than 1.5:1, mixing the oxide of trivalent manganese with a pyrophosphoric acid solution, and reacting to give the complex solution; and
step S2: decomplexation of the complex solution: heating the obtained complex solution for decomplexation to give the manganese phosphate precipitate.

According to the present disclosure, in step S1, the phosphorus-to-manganese ratio is controlled at no less than 1.5:1, and preferably, the phosphorus-to-manganese ratio is 3:1-16:1.

According to the present disclosure, in step S1, the reaction temperature is controlled at 0° C. to 70° C., preferably, at 20° C. to 55° C.

According to the present disclosure, in step S2, the heating temperature is controlled at 50° C.-180° C., preferably, at 70° C. to 120° C. In step S2, a proper amount of water may be added before or during the heating as required; or the system may be pressurized during the heating and/or water addition step(s) with a pressure range of 0.15 Mpa to 2 Mpa (absolute pressure). The inventors of the present disclosure have found that pressurization can increase the rate and efficiency of decomplexation.

In the present disclosure, the “proper amount of water” is an amount by volume of water 0.01-20 folds, preferably 0.01-2 folds, the volume of the solution to be decomplexed, on the basis of the volume of the solution to be decomplexed being 1.

The method for preparing manganese phosphate of the present disclosure comprises two steps. Step S1 is a step of preparing the manganese pyrophosphate complex solution. In this step, pyrophosphate radical reacts with trivalent manganese ion to give a pyrophosphate complex of manganese that is soluble in an aqueous solution. Since the manganese pyrophosphate complex is freely soluble in aqueous solutions while impurities seldom form soluble complexes, insoluble substances can be removed by filtration, thereby improving the purity of the final manganese phosphate product.

Step S2 is a decomplexation step, and in this step, the complex solution obtained in step S1 is subjected to water addition, heating, and/or pressurization to destroy the complex, thereby forming the manganese phosphate precipitate. During the research, the inventors found that the complex can be destroyed by adding water for dilution or heating alone to induce the production of the manganese phosphate precipitate, and pressurization may accelerate the decomplexation process. The combined use of two or three means selected from water addition, heating, and pressurization can accelerate the decomplexation rate or increase the decomplexation degree. For example, when the decomplexation is performed, the combined use of heating and water addition for dilution is superior to the use of heating alone, which is reflected by a temperature for decomplexing in the combined use of the two means lower than that in heating alone. However, considering the post-treatment and cost-efficiency, the industry prefers the decomplexation by heating alone.

According to the present disclosure, in some embodiments of the present disclosure, an impurity removal step may be added after step S1 and before step S2 as required and is referred to as step S11 in the present disclosure. Step S11, impurity removal: subjecting the complex solution obtained by the reaction in step S1 to solid-liquid separation to give the complex solution for use in step S2. Through the solid-liquid separation, the impurities in the starting materials can be removed, or the unreacted trivalent manganese ion can be recycled back to step S1, thus improving the utilization rate of manganese.

According to the present disclosure, in some embodiments of the present disclosure, the method comprises, after the manganese phosphate precipitate is obtained in step S2: performing solid-liquid separation to give a solid manganese phosphate product.

The solid-liquid separation mentioned in steps S11 and S2 is a solid-liquid separation method commonly used in the art, including but not limited to filtration, centrifugal separation, standing and decantation, and the like. In one embodiment of the present disclosure, the solid-liquid separation method is filtration.

According to the present disclosure, in some embodiments of the present disclosure, the method further comprises recovering a large amount of phosphoric acid contained in the mother liquor obtained in step S2. The recovery method comprises concentration to form phosphoric acid of a high concentration, and the recovered phosphoric acid may be commercialized or used in the process for preparing pyrophosphoric acid. For example, P₂O₅ may be used to react with the recovered concentrated phosphoric acid, and the excess water is removed as required to give pyrophosphoric acid.

Therefore, in one embodiment of the first aspect of the present disclosure, provided is a method for preparing manganese phosphate by using pyrophosphoric acid. The method comprises: reacting a pyrophosphoric acid solution with a trivalent manganese-containing oxide to give the manganese pyrophosphate complex solution, and decomplexing to give the manganese phosphate precipitate, wherein the trivalent manganese-containing oxide is selected from dimanganese trioxide.

Preferably, the method comprises, before the decomplexing step: removing unreacted solids by solid-liquid separation, wherein the unreacted solids comprise impurities and/or the unreacted oxide of manganese.

The method for preparing manganese phosphate described above comprises:
step S1: preparation of the complex solution: controlling the phosphorus-to-manganese ratio in starting materials at no less than 1.5:1, mixing a trivalent manganese-containing oxide with a pyrophosphoric acid solution, and reacting to give the complex solution; and
step S2: decomplexation of the complex solution: heating the obtained complex solution for decomplexation to give the manganese phosphate precipitate.

The phosphorus-to-manganese ratio is controlled at no less than 1.5:1, and preferably, the phosphorus-to-manganese ratio is 3:1-16:1.

In step S1, the reaction temperature is controlled at 0° C. to 70° C., more preferably, at 20° C. to 55° C. In step S2, the heating temperature is controlled at 50° C.-180° C., preferably, at 70° C. to 120° C., and a proper amount of water is added before or during the heating as required. The system may be pressurized during the heating and/or water addition step(s) with a pressure range of 0.15 Mpa to 2 Mpa (absolute pressure).

The “proper amount of water” is an amount by volume of water 0.01-20 folds, preferably 0.01-2 folds, the volume of the solution to be decomplexed, on the basis of the volume of the solution to be decomplexed being 1.

The method further comprises, after step S1 and before step S2: step S11, impurity removal: performing solid-liquid separation to give the complex solution.

The method further comprises, after the manganese phosphate precipitate is obtained in step S2: performing solid-liquid separation to give a solid manganese phosphate product.

The solid-liquid separation mentioned in steps S11 and S2 is a solid-liquid separation method commonly used in the art, including but not limited to filtration, centrifugal separation, standing and decantation, and the like. In one embodiment of the present disclosure, the solid-liquid separation method is filtration.

The method further comprises recovering a large amount of phosphoric acid contained in the mother liquor obtained in step S2. The recovery method comprises concentration to form phosphoric acid of a high concentration, and the recovered phosphoric acid may be commercialized or used in the process for preparing pyrophosphoric acid. For example, P₂O₅ may be used to react with the concentrated phosphoric acid, and the excess water is removed as required to give pyrophosphoric acid.

The present invention further claims a method of preparing manganese phosphate, comprising:
step S1: preparation of the complex solution: controlling the phosphorus-to-manganese ratio in starting materials at no less than 1.5:1, mixing manganese oxide with a pyrophosphoric acid solution in a proper ratio, and reacting to give the complex solution;
step S11: impurity removal: performing solid-liquid separation to a complex solution with solids being removed, and optionally, returning the separated solids to step S1 or discharging the solids from the reaction system; and
step S2: decomplexation of the complex solution: heating the complex solution obtained in step S11 for decomplexation to give the manganese phosphate precipitate, and performing solid-liquid separation to give manganese phosphate.

In step S1, the phosphorus-to-manganese ratio is preferably 3:1-16:1.

In step S1, the reaction temperature is controlled at 0° C. to 70° C., more preferably, at 20° C. to 55° C. In step S2, the heating temperature is controlled at 50° C.-180° C., preferably, at 70° C. to 120° C., and a proper amount of water is added before or during the heating as required. The system may be pressurized in addition to the heating and/or water addition step(s) with a pressure range of 0.15 Mpa to 2 Mpa (absolute pressure).

The “proper amount of water” is an amount by volume of water 0.01-20 folds, preferably 0.01-2 folds, the volume of the solution to be decomplexed, on the basis of the volume of the solution to be decomplexed being 1.

Trivalent manganese reacts with pyrophosphoric acid to form a pyrophosphate complex of manganese, which is soluble in water and can be stably present in a solution. Through the solid-liquid separation, the impurities in the starting material trivalent manganese can be removed, or the unreacted trivalent manganese ion can be recovered and returned to step S1, thus improving the utilization rate of trivalent manganese. In the decomplexation process, the pyrophosphate complex of manganese is decomplexed to form a manganese phosphate precipitate, and a manganese phosphate product is obtained after solid-liquid separation.

In another embodiment of the first aspect of the present disclosure, provided is a method for preparing manganese phosphate by using pyrophosphoric acid, comprising: reacting a pyrophosphoric acid solution, a reductant, and a tetravalent manganese-containing oxide to give the manganese pyrophosphate complex solution, and decomplexing to give the manganese phosphate precipitate, wherein the tetravalent manganese-containing oxide is selected from one of manganese dioxide and trimanganese tetraoxide, and a combination thereof; the reductant is selected from an inorganic reductant and/or an organic reductant with a standard electrode potential value of lower than +0.77; preferably, the reducing agent is hydrogen peroxide, a ferrous ion-containing salt including a ferrous inorganic acid salt and a ferrous organic acid salt, a stannous ion-containing salt including a stannous inorganic acid salt and a stannous organic acid salt, a cuprous ion-containing salt including a cuprous inorganic acid salt and a cuprous organic acid salt, a C₁₋₈ acid and a salt thereof, a C₁₋₈ alcohol, a C₁₋₈ aldehyde or a C₃₋₈ ketone, a monosaccharide, a disaccharide or an oligosaccharide; more preferably, the reductant is hydrogen peroxide, formaldehyde, formic acid, oxalic acid, citric acid, ascorbic acid, a ferrous inorganic acid salt, a ferrous organic acid salt, a stannous inorganic acid salt, or a stannous organic acid salt.

Preferably, the method comprises, before the decomplexing step: removing unreacted solids by solid-liquid separation, wherein the unreacted solids comprise impurities and/or the unreacted oxide of manganese.

The method for preparing manganese phosphate described above comprises:
step S1: preparation of the complex solution: controlling the phosphorus-to-manganese ratio in starting materials at no less than 3:1, mixing the tetravalent manganese-containing oxide, the reductant, and the pyrophosphoric acid solution in a proper ratio, and reacting to give the complex solution;
step S2: decomplexation of the complex solution: heating the obtained complex solution to give a precipitate, wherein the precipitate is manganese phosphate monohydrate.

In this reaction, the reductant reduces tetravalent manganese to trivalent manganese. In view of the strong oxidizing property of tetravalent manganese such as manganese dioxide, both inorganic and organic reductants with a reducing property comparable or superior to that of divalent Fe ion can reduce manganese dioxide. Although many inorganic and organic reductants have been tested in the present application, it is not practical to exhaust the selection of reductants, given that there are numerous inorganic and organic reductants with reducing properties comparable or superior to that of hydrogen peroxide.

The inventors have found and confirmed by tests that based on the standard electrode potential values of reductants, reductants with a standard electrode potential value lower than and equal to that of Fe³⁺/Fe²⁺ can be used in the reaction of the present disclosure. According to “Handbook of Standard Electrode Potentials” (Science Press, edited by Wu Weichang et al., 1991 edition), the standard electrode potential value of Fe³⁺/Fe²⁺ is +0.77. Reductant substances with standard electrode potential values lower than the standard electrode potential include, for example, hydrogen peroxide (O₂+H⁺/H₂O₂) with a standard electrode potential value of +0.69, formic acid/formaldehyde (HCOOH/HCHO) with a value of 0.056 V, and Sn⁴⁺/Sn²⁺ with a value of 0.151 V.

Thus, the reductant in the present disclosure includes all reductants with a standard electrode potential of lower than 0.77, including inorganic reductants and organic reductants, wherein the inorganic reductants include hydrogen peroxide or inorganic salts formed by metal ions with a low valence, such as ferrous inorganic acid salts, stannous inorganic acid salts, and cuprous inorganic acid salts; the organic reductants include C₁₋₈ acids and salts, C₁₋₈ alcohols, C₁₋₈ aldehydes, C₃₋₈ ketones, monosaccharides, disaccharides or oligosaccharides, organic acid salts and organic complexes formed with metals, and the like, such as formaldehyde, formic acid, citric acid, oxalic acid, ascorbic acid, and corresponding salts and complexes.

The phosphorus-to-manganese ratio is controlled at no less than 3:1, and preferably, the phosphorus-to-manganese ratio is 4:1-16:1. The molar ratio of the reductant to manganese is calculated on the basis of the change in valence of the reductant after oxidation. For example, when ferrous iron is oxidized to ferric ion, the chemical molar ratio of ferrous iron to manganese is 1:1. The molar ratio of the reductant to manganese is (0.1-10):1, preferably (0.3-3):1.

In step S1, the reaction temperature is controlled at 0° C. to 70° C., more preferably, at 20° C. to 55° C. In step S2, the heating temperature is controlled at 50° C.-180° C., preferably, at 70° C. to 120° C., and a proper amount of water is added before or during the heating as required. The system may be pressurized in addition to the heating and/or water addition step(s) with a pressure range of 0.15 Mpa to 2 Mpa (absolute pressure).

The “proper amount of water” is an amount by volume of water 0.01-20 folds, preferably 0.01-2 folds, the volume of the solution to be decomplexed, on the basis of the volume of the solution to be decomplexed being 1.

The method further comprises, after step S1 and before step S2: step S11, impurity removal: performing solid-liquid separation to give the complex solution.

The method further comprises, after the manganese phosphate precipitate is obtained in step S2: performing solid-liquid separation to give a solid manganese phosphate product.

The solid-liquid separation mentioned in steps S11 and S2 is a solid-liquid separation method commonly used in the art, including but not limited to filtration, centrifugal separation, standing and decantation, and the like. In one embodiment of the present disclosure, the solid-liquid separation method is filtration.

The method further comprises recovering a large amount of phosphoric acid contained in the mother liquor obtained in step S2. The recovery method comprises concentration to form phosphoric acid of a high concentration, and the recovered phosphoric acid may be commercialized or used in the process for preparing pyrophosphoric acid. For example, P₂O₅ may be used to react with the concentrated phosphoric acid, and the excess water is removed as required to give pyrophosphoric acid.

In order to reduce the production cost, the inventors used a more common and cost-efficient starting material manganese dioxide instead of the oxide of trivalent manganese, but found that when the oxide of tetravalent manganese is used to react with pyrophosphoric acid, the reaction effect is relatively poor, and the yield of manganese phosphate is extremely low. After the addition of a reductant, the yield of the reaction between the oxide of tetravalent manganese and pyrophosphoric acid can be greatly improved. The range of reductants suitable for use in the present disclosure is very broad. Although hydrogen peroxide has a strong oxidizing property, when reacting with an oxide of tetravalent manganese, hydrogen peroxide becomes a reductant and reduces tetravalent manganese to give trivalent manganese ions, which also results in a manganese pyrophosphate complex. Therefore, substances with substantially comparable or superior reducing property to that of hydrogen peroxide can be used in the present disclosure as the reductant.

The present invention further claims a method of preparing manganese phosphate, comprising:
step S1: preparation of the complex solution: controlling the phosphorus-to-manganese ratio in starting materials at no less than 3:1, mixing the manganese-containing oxide, the reductant, and the pyrophosphoric acid solution in a proper ratio, and reacting to give the complex solution;
step S11: impurity removal: performing solid-liquid separation to a complex solution, and optionally, returning the separated solids to step S1 or discharging the solids from the reaction system; and
step S2: decomplexation of the complex solution: heating the obtained complex solution for decomplexation to give the precipitate, and performing solid-liquid separation to give manganese phosphate monohydrate.

In step S1, the phosphorus-to-manganese ratio is preferably 4:1-16:1.

In step S1, the molar ratio of the reductant to manganese is (0.1-10):1, preferably (0.3-3):1.

In step S1, the reaction temperature is controlled at 0° C. to 70° C., more preferably, at 20° C. to 55° C. In step S2, the heating temperature is controlled at 50° C.-180° C., preferably, at 70° C. to 120° C., and a proper amount of water is added before or during the heating as required. The system may be pressurized in addition to the heating and/or water addition step(s) with a pressure range of 0.15 Mpa to 2 Mpa (absolute pressure).

The “proper amount of water” is an amount by volume of water 0.01-20 folds, preferably 0.01-2 folds, the volume of the solution to be decomplexed, on the basis of the volume of the solution to be decomplexed being 1.

Tetravalent manganese and the reductant react with pyrophosphoric acid to form a pyrophosphate complex of trivalent manganese, which is soluble in water and can be stably present in a solution. Through the solid-liquid separation, the impurities in tetravalent manganese oxide can be removed, or the unreacted oxide of manganese can be recovered and returned to step S1, thus improving the utilization rate of the starting oxide of manganese. In the decomplexation process, the pyrophosphate complex of manganese is decomplexed to form a manganese phosphate precipitate, and a manganese phosphate product is obtained after solid-liquid separation.

In another embodiment of the first aspect of the present disclosure, provided is a method for preparing manganese phosphate by using pyrophosphoric acid, comprising: reacting a pyrophosphoric acid solution, an oxidant, and a divalent manganese-containing oxide to give the manganese pyrophosphate complex solution, and decomplexing to give the manganese phosphate precipitate, wherein the divalent manganese-containing oxide is manganese monoxide (MnO) or trimanganese tetraoxide (Mn₃O₄).

The oxidant is selected from MnO₂, Mn₂O₆, manganous acid, manganous anhydride (Mn₂O₅), manganic acid (H₂MnO₄), manganic anhydride (MnO₃), HMnO₄, and permanganic anhydride, or may be selected from an alkali metal or alkaline earth metal manganate or permanganate salt and the like. The alkali metal salt or the alkaline earth metal salt are selected from a salt of an alkali metal such as potassium, sodium and lithium, and a salt of an alkaline earth metal such as calcium, magnesium, barium and cesium. The alkali metal or alkaline earth metal manganate or permanganate salt may also be used as an oxidant, but may lead to the introduction of heteroions and thus require subsequent procedures to remove the heteroions, such as separation and removal from the product or starting material by solid-liquid separation. The oxidant is selected from one of MnO₂, Mn₂O₆, manganous acid, manganous anhydride, manganic acid, manganic anhydride, HMnO₄, permanganic anhydride and potassium permanganate, or a combination thereof, most preferably, the oxidant is MnO₂ or potassium permanganate.

In fact, oxidants capable of oxidizing Mn²⁺ to Mn³⁺, such as perchloric acid and concentrated nitric acid, can theoretically help accomplish the method but may introduce heteroatoms such as chloride ions or nitrate ions.

Preferably, the method comprises, before the decomplexing step: removing unreacted solids by solid-liquid separation, wherein the unreacted solids comprise impurities and/or the unreacted starting material divalent manganese-containing oxide.

The method for preparing manganese phosphate described above comprises:
step S1: preparation of the complex solution: controlling the phosphorus-to-manganese ratio in starting materials at no less than 3:1, mixing the divalent manganese-containing oxide, the oxidant, and the pyrophosphoric acid solution in a proper ratio, and reacting to give the complex solution;
step S2: decomplexation of the complex solution: heating the obtained complex solution to give a precipitate, wherein the precipitate is manganese phosphate monohydrate.

In this reaction, the oxidant oxidizes divalent manganese to trivalent manganese. Trivalent manganese forms a complex with pyrophosphate ions, and the complex is dissolved in the solution.

In step S1, the phosphorus-to-manganese ratio is controlled at no less than 3:1, such as 3:1-20:1, and preferably, the phosphorus-to-manganese ratio is 4:1-16:1.

The theoretical value is calculated on the basis of the change in valence before and after the reaction, and the molar ratio of the oxidant to the oxide of divalent manganese is 0.7-1.3 folds the theoretical value, preferably 0.8-1.2 folds, and more preferably 0.9-1.1 folds. The change in the valence refers to changes in valence values of the oxidant and the divalent manganese in the reaction process. The molar ratio is calculated on the basis of the change in valence before and after the reaction. For example, if the oxidant is MnO₂, the theoretically calculated value of the molar ratio of MnO₂ to MnO is 1:1 as calculated from the valence change. In this case, for 1 mol of MnO, the theoretical addition amount of MnO₂ is 1 mol, and accordingly, the molar amount of MnO₂ added is within the range of 0.7-1.3 mol. When the oxidant is potassium permanganate, the theoretical molar ratio of KMnO₄ to MnO is 1:4, and accordingly, the molar ratio of KMnO4 to MnO varies from 1:2.8 to 1:5.2 (calculated as per ±30%).

In step S1, the reaction temperature is controlled at 0° C. to 70° C., more preferably, at 20° C. to 55° C. In step S2, the heating temperature is controlled at 50° C.-180° C., preferably, at 70° C. to 120° C., and a proper amount of water is added before or during the heating as required. The system may be pressurized in addition to the heating and/or water addition step(s) with a pressure range of 0.15 Mpa to 2 Mpa (absolute pressure).

The “proper amount of water” is an amount by volume of water 0.01-20 folds, preferably 0.01-2 folds, the volume of the solution to be decomplexed, on the basis of the volume of the solution to be decomplexed being 1.

The method further comprises, after step S1 and before step S2: S11, impurity removal: performing solid-liquid separation to give the complex solution.

The method further comprises, after the precipitate is obtained in step S2: performing solid-liquid separation to give manganese phosphate monohydrate.

The solid-liquid separation mentioned in steps S11 and S2 is a solid-liquid separation method commonly used in the art, including but not limited to filtration, centrifugal separation, standing and decantation, and the like. In one embodiment of the present disclosure, the solid-liquid separation method is filtration.

The method further comprises recovering a large amount of phosphoric acid contained in the mother liquor obtained in step S2. The recovery method comprises concentration to form phosphoric acid of a high concentration, and the recovered phosphoric acid may be commercialized or used as a starting material for preparing pyrophosphoric acid. For example, P₂O₅ may be used to react with the concentrated phosphoric acid, and the excess water is removed as required to give pyrophosphoric acid.

The present invention further claims a method of preparing manganese phosphate, comprising:
step S1: preparation of the complex solution: controlling the phosphorus-to-manganese ratio in starting materials at no less than 3:1, mixing the oxide of manganese, the oxidant, and the pyrophosphoric acid solution in a proper ratio, and reacting to give the complex solution;
step S11: impurity removal: performing solid-liquid separation to a complex solution, and optionally, returning the separated solids to step S1 or discharging the solids from the reaction system; and
step S2: decomplexation of the complex solution: heating the obtained complex solution to give the precipitate, and performing solid-liquid separation to give manganese phosphate monohydrate.

In step S1, the phosphorus-to-manganese ratio is preferably 4:1-16:1.

In step S1, the ratio of the oxidant to the divalent manganese is calculated based on the valence and adjusted by about +20% according to the theoretically calculated value. That is, the molar ratio of the oxidant to divalent manganese is 0.8-1.2 folds the theoretically calculated ratio.

In step S1, the reaction temperature is controlled at 0° C. to 70° C., more preferably, at 20° C. to 55° C. In step S2, the heating temperature is controlled at 50° C.-180° C., preferably, at 70° C. to 120° C., and a proper amount of water is added before or during the heating as required. The system may be pressurized in addition to the heating and/or water addition step(s) with a pressure range of 0.15 Mpa to 2 Mpa (absolute pressure).

The “proper amount of water” is an amount by volume of water 0.01-20 folds, preferably 0.01-2 folds, the volume of the solution to be decomplexed, on the basis of the volume of the solution to be decomplexed being 1.

Divalent manganese and the oxidant react with pyrophosphoric acid to form a pyrophosphate complex of trivalent manganese, which is soluble in water and can be stably present in a solution. Through the solid-liquid separation, the impurities in divalent manganese oxide can be removed, or the unreacted oxide of manganese can be recovered and returned to step S1, thus improving the utilization rate of the starting oxide of manganese. In the decomplexation process, the pyrophosphate complex of manganese is decomplexed to form a manganese phosphate precipitate, and a manganese phosphate product is obtained after solid-liquid separation.

In a second aspect of the present disclosure, provided is a method for preparing carbon-coated lithium manganese iron phosphate, comprising: mixing manganese phosphate, ferric phosphate, lithium hydroxide, and a carbon source material, and calcining at 500-1000° C. to give carbon-coated lithium manganese iron phosphate.

The molar ratio of lithium to manganese and iron is controlled at [Li:(Mn+Fe)]=(1.05-1.10):1, and the molar ratio of manganese to iron (Mn:Fe) is controlled at (0.01-0.99):(0.99-0.01).

The manganese phosphate is prepared by the method described in the first aspect of the present disclosure.

The carbon source material is any material that can provide C element during high-temperature calcination. The carbon source material includes, but is not limited to, organic small-molecule carbon source materials, such as one or more of glucose, sucrose, tartaric acid, urea, ascorbic acid, citric acid, gluconic acid, and cellobiose, or organic macromolecular polymer carbon source materials, such as one or more of polyethylene glycol, polyvinyl alcohol, polypropylene glycol, soluble starch, phenolic resin, and epoxy resin.

In a third aspect of the present disclosure, provided is a battery using carbon-coated lithium manganese iron phosphate as the positive electrode material, wherein the carbon-coated lithium manganese iron phosphate uses manganese phosphate prepared by the method described in the first aspect of the present disclosure as the manganese source material.

### TERMINOLOGY AND DEFINITIONS

Phosphorus-to-manganese ratio: In the present disclosure, the phosphorus-to-manganese ratio refers to the molar ratio of phosphorus to manganese. For example, the molar ratio of the phosphorus source to the manganese source is controlled in the reaction starting material system. A low phosphorus-to-manganese ratio indicates a lower amount of pyrophosphoric acid, and reducing the phosphorus-to-manganese ratio will effectively improve the cost-efficiency. However, a low phosphorus-to-manganese ratio will lead to a reduced reaction rate, a low yield of the complex, and even the possibility of nonreactivity. Conversely, a high phosphorus-to-manganese ratio, such as a phosphorus-to-manganese ratio of 20:1 or even 30:1, can still achieve the objectives of the present disclosure, but will lead to problems such as highly excessive consumption of pyrophosphoric acid, cost-inefficiency, difficulties in decomplexing the complex, and difficulties in post-treatment. The phosphorus-to-manganese ratio is defined as no less than 1.5:1 in the present disclosure, which substantially includes the phosphorus-to-manganese ratio of 1.5:1 and a higher phosphorus-to-manganese ratio up to, for example, 2:1, 3:1, 4:1, 8:1, 16:1, 20:1, 30:1, 40:1, and even 100:1.

Trivalent manganese-containing oxide: In the present disclosure, the trivalent manganese-containing oxide is an oxide of manganese containing trivalent manganese element. It is also referred to as manganese oxide in the present disclosure.

Tetravalent manganese-containing oxide: In the present disclosure, tetravalent manganese-containing oxide is an oxide of manganese containing tetravalent manganese element. It is also referred to as manganese oxide or an oxide of manganese in the present disclosure, including manganese dioxide, trimanganese tetraoxide, or other oxides containing tetravalent manganese. Trimanganese tetraoxide (Mn₃O₄) has a composition of 2MnO·MnO₂ and is also a tetravalent manganese-containing oxide.

Divalent manganese-containing oxide: In the present disclosure, divalent manganese-containing oxide is an oxide of manganese containing a divalent manganese element. It includes manganese monoxide and trimanganese tetraoxide in the present disclosure.

Decomplexation: Decomplexation means destroying the complex in the solution, and in the present disclosure, it refers to destroying the manganese pyrophosphate complex in the solution to form a manganese phosphate precipitate.

Lithium manganese iron phosphate: The lithium manganese iron phosphate described in the present disclosure is sometimes referred to as lithium iron manganese phosphate.

Manganese pyrophosphate complex: The manganese pyrophosphate complex or a pyrophosphate complex of manganese in the present disclosure refers to a complex formed by trivalent manganese and pyrophosphoric acid.

Manganese phosphate: The manganese phosphate described in the present disclosure is MnPO₃, wherein the Mn ion is trivalent. It is often present in the form of manganese phosphate monohydrate (MnPO₄·H₂O) or the monohydrate of manganese phosphate in the present disclosure. The method for preparing manganese phosphate described in the present disclosure often refers to a method for preparing the monohydrate of manganese phosphate or manganese phosphate monohydrate.

The “inorganic reductants and/or organic reductants with a standard electrode potential value lower than +0.77” refers to compounds or substances with a standard electrode potential lower than +0.77 and a theoretically stronger reducing property. Since the value of the standard electrode potential of Fe³⁺/Fe²⁺ is +0.77, the reductant substantially includes inorganic reductants and organic reductants having a reducing property comparable or superior to that of ferrous ion (Fe²⁺). The substances include inorganic compounds, organic compounds, or mixtures thereof.

The C₁₋₈ acids and salts thereof, C₁₋₈ alcohols, C₁₋₈ aldehydes, or C₃₋₈ ketones refer to organic compounds with the defined carbon atoms and corresponding functional groups. For example, the C₁₋₈ acids and salts thereof are organic acids that contain 1-8 carbon atoms and one or more carboxylic acid functional groups, or further contain an OH functional group, including but not limited to formic acid, acetic acid, citric acid, oxalic acid, and salts containing carboxylate ions. The C₁₋₈ alcohols contain 1-8 carbon atoms, one or more OH functional groups, and a carbon chain, a carbocyclic ring, or a heterocyclic group, such as ascorbic acid; the C₃₋₈ ketones are compounds that contain 3-8 carbon atoms and one or more keto groups, and may further contain an OH functional group; the C₁₋₈ aldehydes are compounds that contain 1-8 carbon atoms and one or more aldehyde groups, and may further contain an OH functional group.

The monosaccharides, disaccharides, or oligosaccharides include common carbohydrate sugars such as glucose, fructose, sucrose, or oligosaccharides that can be hydrolyzed to 3-5 monosaccharide molecules.

The ferrous inorganic acid salts refer to inorganic acid salts containing ferrous iron, such as ferrous sulfate, ferrous chloride, ferrous phosphate, and ferrous nitrate.

The ferrous organic acid salts refer to organic acid salts containing ferrous iron, such as ferrous oxalate, ferrous acetate, ferrous formate, and ferrous citrate.

The stannous inorganic acid salts refer to inorganic acid salts containing divalent tin, such as stannous sulfate, stannous chloride, stannous phosphate, and stannous nitrate.

The stannous organic acid salts refer to organic acid salts containing divalent tin, such as stannous oxalate, stannous acetate, stannous formate, and stannous citrate.

The cuprous inorganic acid salts refer to inorganic acid salts containing monovalent copper, such as cuprous sulfate, cuprous chloride, cuprous phosphate, and cuprous nitrate.

The cuprous organic acid salts refer to organic acid salts containing monovalent copper, such as cuprous oxalate, cuprous acetate, cuprous formate, and cuprous citrate.

### Beneficial Effects

The method for preparing manganese phosphate of the present disclosure has the following effects:
1. By forming a complex using a trivalent Mn oxide, a divalent Mn oxide and/or a tetravalent Mn oxide, and pyrophosphoric acid, insoluble impurities can be removed, and compared with the current synthesis method using Mn(NO₃)₂ as the manganese source, the method produces no toxic gases such as NO and NO₂, thus possessing good safety;
2. No impurity ions are introduced in the production process or impurities can be removed by solid-liquid separation, thereby improving the purity of the product and reducing the steps of sewage treatment; compared with the hydrothermal and solvothermal methods, the method offers superior controllability in synthesis conditions and good cost-efficiency.

### BRIEF DESCRIPTION OF THE DRAWINGS

FIG. 1 is an XRD pattern of MnPO₄·H₂O prepared according to Example 1-1.

FIG. 2 is a SEM image of MnPO₄·H₂O prepared according to Example 1-1.

FIG. 3 is an XRD pattern of LiMn_{0.6}Fe_{0.4}PO₄ prepared according to Example 1-4.

FIG. 4 is an XRD pattern of MnPO₄·H₂O prepared according to Example 2-1.

FIG. 5 is a SEM image of MnPO₄·H₂O prepared according to Example 2-1.

FIG. 6 is an XRD pattern of MnPO₄·H₂O prepared according to Example 3-1.

FIG. 7 is a SEM image of MnPO₄·H₂O prepared according to Example 3-1.

FIG. 8 is an XRD pattern of MnPO₄·H₂O prepared according to Example 3-2.

FIG. 9 is a SEM image of MnPO₄·H₂O prepared according to Example 3-2.

FIG. 10 is an XRD pattern of LiMn_{0.6}Fe_{0.4}PO₄ prepared according to Example 3-7.

### DETAILED DESCRIPTION

The embodiments of the present disclosure will be further illustrated in detail with reference to the following specific examples. It will be appreciated that the following examples are merely exemplary illustrations and explanations of the present disclosure, and should not be construed as limiting the claimed scope of the present disclosure. All techniques implemented based on the content of the present disclosure described above are included within the claimed scope of the present disclosure.

Unless otherwise stated, the starting materials and reagents used in the following examples are all commercially available products, or can be prepared by using known methods.

### Example 1-1: Mn₂O₃ as Oxide of Manganese

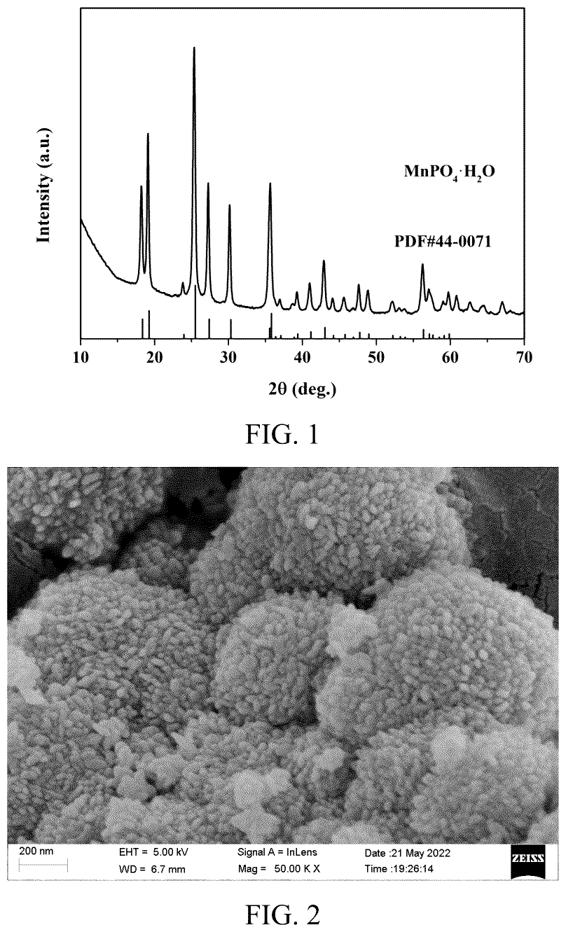

55.62 g of pyrophosphoric acid solid was accurately weighed and dissolved in 50 mL of deionized water to form an aqueous pyrophosphoric acid solution. 3.9468 g of Mn₂O₃ powder was accurately weighed and then added to the pyrophosphoric acid solution, and the mixture was stirred to dissolve the powder completely. The resulting mixture was warmed to 50° C., incubated for 1 h, and then filtered to remove the filter residue to give a dark purple solution. The solution was heated to 100° C. and incubated for 6 h, and a large amount of pale green precipitate was precipitated in the solution. The precipitate was separated by filtration, washed, and dried to give MnPO₄·H₂O (5.1315 g). The overall yield of the reaction was 58%. The resulting pale green powder was subjected to X-ray diffraction to give an XRD pattern shown in FIG. 1, suggesting that the product was MnPO₄·H₂O. The resulting pale green manganese phosphate powder was detected by SEM to give a scanning electron microscope image shown in FIG. 2, demonstrating that the powder consisted of nanoparticles of around 50 nm in size.

### Example 1-2: Mn₂O₃ as Oxide of Manganese

16.68 g of pyrophosphoric acid solid was accurately weighed and dissolved in 50 mL of deionized water to form an aqueous pyrophosphoric acid solution. 3.9468 g of Mn₂O₃ powder was accurately weighed and then added to the pyrophosphoric acid solution, and the mixture was stirred to dissolve the powder completely. The resulting mixture was warmed to 50° C. and incubated for 1 h to give a dark purple solution. The mixture was filtered to remove the residues. The dark purple solution was warmed to 100° C. and incubated for 6 h, and a large amount of pale green precipitate was precipitated in the solution. The precipitate was separated by filtration, washed, and dried to give a pale green powder (3.5273 g). The XRD pattern demonstrates that the powder was MnPO₄·H₂O. The overall yield of the reaction was 39.9%.

### Example 1-3: Mn₂O₃ as Oxide of Manganese

14.0510 g of pyrophosphoric acid solid was accurately weighed and dissolved in 50 mL of deionized water to form a 3 M aqueous pyrophosphoric acid solution. 3.9468 g of Mn₂O₃ powder was accurately weighed and then added to the pyrophosphoric acid solution, and the mixture was stirred to dissolve the powder completely. The resulting mixture was stirred at room temperature for 1 h and then filtered to remove the filter residue to form a wine-red solution. 50 mL of deionized water was added to the solution described above, and the mixture was heated to 90° C. and incubated for 6 h. The obtained pale green precipitate was washed and filtered to give a pale green powder (2.6554 g). The XRD pattern demonstrates that the powder was MnPO₄·H₂O.

### Example 1-4: Preparation of Carbon-Coated Lithium Manganese Iron Phosphate

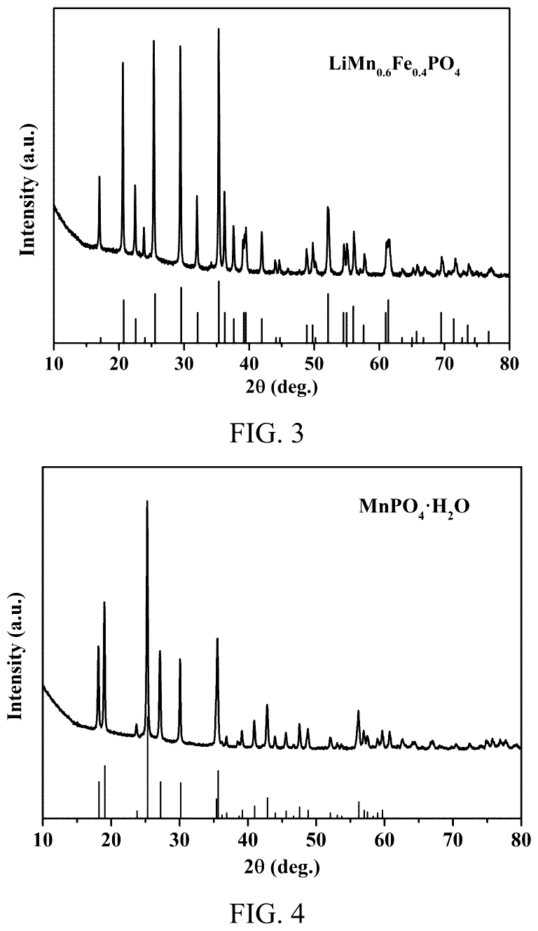

0.3022 g of the MnPO₄·H₂O powder prepared in Example 1-1, 0.2243 g of FePO₄·2H₂O powder, 0.1320 g of LiOH·H₂O powder, and 0.3780 g of glucose were weighed. The four powders were mixed uniformly and then transferred to a tube furnace. An inert gas nitrogen was introduced, and the mixture was calcined at 750° C. for 12 h. After the reaction was completed, the mixture was naturally cooled to room temperature to give a LiMn_{0.6}Fe_{0.4}PO₄/C material. The XRD pattern of the prepared lithium manganese iron phosphate powder is shown in FIG. 3.

### Example 2-1: MnO₂+H₄P₂O₇+H₂O₂

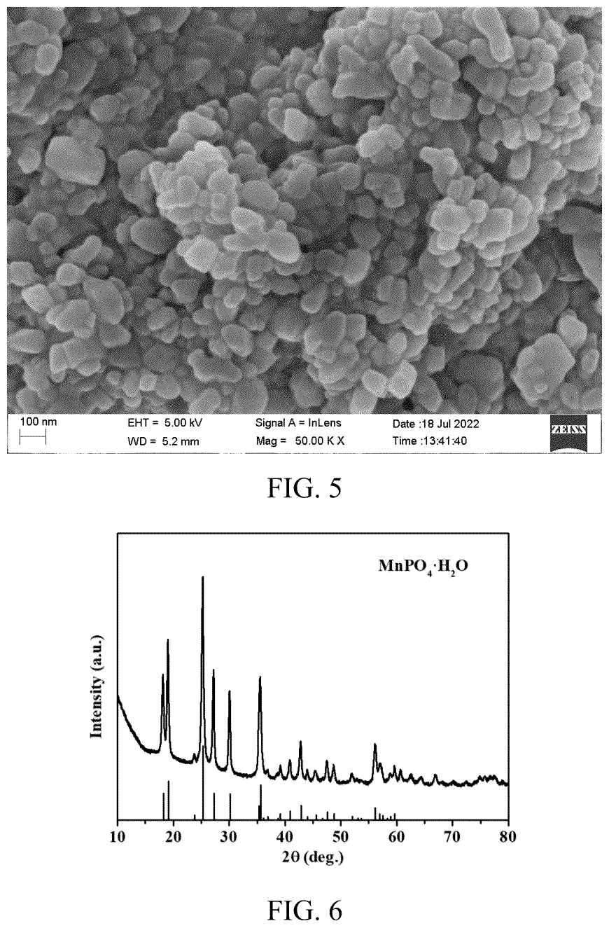

55.62 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 3 mL of 30% H₂O₂ solution was taken and added dropwise to the pyrophosphoric acid solution to give a dark purple solution. After the addition of the H₂O₂ solution was completed, the system was warmed to 50° C. and incubated for 20 min. The mixture was filtered to remove the residues. The purple solution was transferred to a flask, heated to 90° C., and incubated for 6 h to give a cyan solution. The precipitate was separated by filtration, washed, and dried to give a pale green powder (5.0971 g). The resulting pale green powder was subjected to X-ray diffraction to give an XRD pattern shown in FIG. 4, suggesting that the product was MnPO₄·H₂O. The resulting pale green manganese phosphate powder was detected by SEM to give a scanning electron microscope image shown in FIG. 5.

### Example 2-2: MnO₂+H₄P₂O₇+H₂C₂O₄·2H₂O

55.62 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 2.1011 g of H₂C₂O₄·2H₂O was taken and added in batches to the pyrophosphoric acid solution to give a dark purple solution. The entire reaction process was very stable, without producing numerous bubbles. After the addition of the solid H₂C₂O₄·2H₂O was completed, the system was warmed to 50° C. and incubated for 20 min. The mixture was filtered to remove the residues. The dark purple solution was transferred to a pressure-resistant flask, heated to 100° C., and incubated for 6 h to give a cyan solution. The precipitate was separated by filtration, washed, and dried to give a cyan powder (5.5673 g). The XRD pattern demonstrates that the powder was crystalline MnPO₄·H₂O.

### Example 2-3: MnO₂+H₄P₂O₇+HCHO

55.62 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 1.3 mL of formaldehyde solution was taken and added dropwise to the pyrophosphoric acid solution. After the addition was completed, the system was warmed to 50° C. and incubated for 20 min. The mixture was filtered to remove the residues. The purplish red solution was transferred to a three-necked flask, heated to 100° C., and incubated for 6 h to give a cyan solution. The precipitate was separated by filtration, washed, and dried to give a cyan powder (2.7022 g). The XRD pattern demonstrates that the powder was crystalline MnPO₄·H₂O.

### Example 2-4: MnO₂+H₄P₂O₇+HCOOH

55.62 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 2.18 mL of formic acid solution was taken and added dropwise to the pyrophosphoric acid solution. After the addition was completed, the system was warmed to 50° C. and incubated for 30 min. Numerous bubbles were produced during the incubation. The mixture was filtered to remove the residues. The purplish red solution was transferred to a three-necked flask, heated to 100° C., and incubated for 6 h to give a cyan solution. The precipitate was separated by filtration, washed, and dried to give a cyan powder (3.1437 g). The XRD pattern demonstrates that the powder was crystalline MnPO₄·H₂O.

### Example 2-5: MnO₂+H₄P₂O₇+Citric Acid

55.62 g of pyrophosphoric acid solid was accurately weighed and dissolved in 50 ml of deionized water to form an aqueous pyrophosphoric acid solution. 4.347 g of MnO₂ powder was accurately weighed and then added to the pyrophosphoric acid solution, and the mixture was stirred. 0.6 g of citric acid powder was taken and added in batches to the pyrophosphoric acid solution. After the addition was completed, the system was warmed to 50° C. and incubated for 1 h. Bubbles were produced during the incubation. The mixture was filtered to remove the residues. The purplish red solution was transferred to a three-necked flask, heated to 100° C., and incubated for 6 h to give a cyan solution. The precipitate was separated by filtration, washed, and dried to give a cyan powder (4.3505 g). The XRD pattern demonstrates that the powder was crystalline MnPO₄·H₂O.

### Example 2-6: MnO₂+H₄P₂O₇+Ascorbic Acid (Vitamin C)

55.62 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 0.4892 g of ascorbic acid powder was taken and added in batches to the pyrophosphoric acid solution. After the addition of the solid powder was completed, the system was warmed to 50° C. and incubated for 20 min. The mixture was filtered to remove the residues. The purplish red solution was transferred to a pressure-resistant flask, heated to 100° C., and incubated for 6 h to give a cyan solution. The precipitate was separated by filtration, washed, and dried to give a cyan powder (2.0602 g). The XRD pattern demonstrates that the powder was crystalline MnPO₄·H₂O.

### Example 2-7: MnO₂+H₄P₂O₇+Ferrous Ion

55.62 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 13.9005 g of FeSO₄·7H₂O was taken and added in batches to the pyrophosphoric acid solution to give a purplish red solution. After the addition of the solid was completed, the system was warmed to 50° C. and incubated for 20 min. The mixture was filtered to remove the residues. The purplish red solution was transferred to a pressure-resistant flask, heated to 100° C., and incubated for 6 h to give a cyan solution. The precipitate was separated by filtration, washed, and dried to give a cyan powder (7.1206 g). The XRD pattern demonstrates that the powder was crystalline MnPO₄·H₂O.

### Example 2-8: MnO₂+H₄P₂O₇+Stannous Ion

55.62 g of pyrophosphoric acid solid was accurately weighed and dissolved in 50 mL of deionized water to form an aqueous pyrophosphoric acid solution, and 4.3 mL of 36.5% HCl solution was added to the pyrophosphoric acid solution. 4.347 g of MnO₂ powder was accurately weighed and then added to the pyrophosphoric acid solution, and the mixture was stirred. 5.6405 g of SnCl₂·2H₂O powder was taken and added in batches to the pyrophosphoric acid solution. After the addition of the solid powder was completed, the system was warmed to 50° C. and incubated for 20 min. During the incubation, the solution was initially colorless and transparent, and then turned purplish red. The mixture was filtered to remove the residues. The purplish red solution was transferred to a pressure-resistant flask, heated to 100° C., and incubated for 6 h to give a cyan solution. The precipitate was separated by filtration, washed, and dried to give a cyan powder (1.9370 g). The XRD pattern demonstrates that the powder was crystalline MnPO₄·H₂O.

### Example 2-9: MnO₂+H₄P₂O₇+H₂O₂

27.81 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 3 mL of 30% H₂O₂ solution was taken and added dropwise to the pyrophosphoric acid solution to give a dark purple solution. After the addition of the H₂O₂ solution was completed, the system was warmed to 50° C. and incubated for 20 min. The mixture was filtered to remove the residues. The dark purple solution was transferred to a pressure-resistant flask, heated to 100° C., and incubated for 3 h to give a cyan solution. The precipitate was separated by filtration, washed, and dried to give a cyan powder (5.0537 g). The XRD pattern demonstrates that the powder was crystalline MnPO₄·H₂O.

### Example 2-10: MnO₂+H₄P₂O₇+H₂O₂

27.82 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 3 mL of 30% H₂O₂ solution was taken and added dropwise to the pyrophosphoric acid solution to give a dark purple solution. After the addition of the H₂O₂ solution was completed, the system was warmed to 50° C. and incubated for 20 min. The mixture was filtered to remove the residues. The dark purple solution was transferred to a hydrothermal reactor, heated to 160° C., and incubated for 6 h to give a cyan solution. The precipitate was separated by filtration, washed, and dried to give a cyan powder (4.4668 g). The XRD pattern demonstrates that the powder was crystalline MnPO₄·H₂O.

### Example 2-11: MnO₂+H₄P₂O₇+H₂O₂

27.82 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. 2 mL of 30% H₂O₂ solution was taken and added dropwise to the pyrophosphoric acid solution to give a dark purple solution. After the addition of the H₂O₂ solution was completed, the system was warmed to 50° C. and incubated for 20 min. The mixture was filtered to remove the residues. The dark purple solution was transferred to a pressure-resistant flask, heated to 100° C., and incubated for 6 h to give a cyan solution. The precipitate was separated by filtration, washed, and dried to give a cyan powder (5.5578 g). The XRD pattern demonstrates that the powder was crystalline MnPO₄·H₂O.

### Example 2-12: Mn₃O₄+H₄P₂O₇+H₂O₂

55.62 g of pyrophosphoric acid solid was accurately weighed and dissolved in 50 mL of deionized water to form an aqueous pyrophosphoric acid solution. 3.8135 g of Mn₃O₄ powder was accurately weighed and then added to the pyrophosphoric acid solution, and the mixture was stirred. 1 mL of 30% H₂O₂ solution was taken and added dropwise to the pyrophosphoric acid solution to give a dark purple solution. After the addition of the H₂O₂ solution was completed, the system was warmed to 50° C. and incubated for 20 min. The mixture was filtered to remove the residues. The dark purple solution was transferred to a three-necked flask, heated to 90° C., and incubated for 6 h to give a cyan solution. The precipitate was separated by filtration, washed, and dried to give a pale green powder (1.8942 g). The XRD pattern of the powder demonstrates that the powder was MnPO₄ H₂O.

### Comparative Example 1: Without Reductant

27.82 g of pyrophosphoric acid solid was accurately weighed and dissolved in 50 mL of deionized water to form an aqueous pyrophosphoric acid solution. 4.347 g of MnO₂ powder was accurately weighed and then added to the pyrophosphoric acid solution, and the mixture was stirred. The system was warmed to 50° C. and incubated for 1 h. The mixture was filtered to remove the filter residue to give a purple solution. The purple solution was transferred to a pressure-resistant flask, heated to 100° C., and incubated for 20 h to give a pale cyan solution. The precipitate was separated by filtration, washed, and dried to give a pale cyan powder (0.2467 g). The XRD pattern demonstrates that the powder was crystalline MnPO₄·H₂O.

### Example 3-1: MnO—KMnO₄—H₄P₂O₇

55.62 g of pyrophosphoric acid solid was accurately weighed and dissolved in 50 ml of deionized water to form an aqueous pyrophosphoric acid solution. 2.8376 g of MnO powder was accurately weighed and then added to the pyrophosphoric acid solution, and the mixture was stirred to give a pink solution. 1.5798 g of KMnO₄ was accurately weighed and added in batches to the Mn²⁺-containing solution described above, and the solution gradually turned dark purplish red. The system was then warmed to 50° C. and incubated for 20 min. The mixture was filtered to remove the residues. The dark purplish red solution was transferred to a flask, heated to 100° C., and incubated for 6 h to give a cyan solution. The precipitate was separated by filtration, washed, and dried to give a pale green powder (8.2370 g).

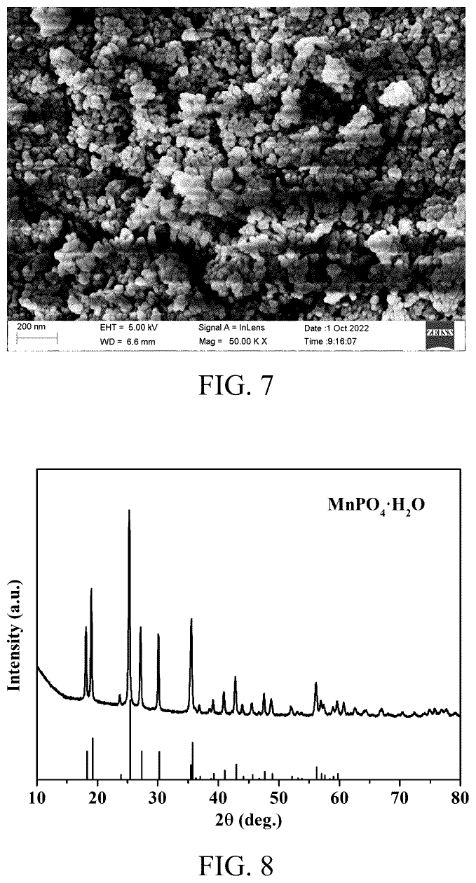

The resulting pale green powder was subjected to X-ray diffraction to give an XRD pattern shown in FIG. 6, suggesting that the product was MnPO₄·H₂O. The resulting pale green manganese phosphate powder was detected by SEM to give a scanning electron microscope image shown in FIG. 7. It can be seen from the figure that the powder particle size is less than 50 nm.

### Example 3-2: MnO—MnO₂—H₄P₂O₇

55.62 g of pyrophosphoric acid solid was accurately weighed and dissolved in 50 mL of deionized water to form an aqueous pyrophosphoric acid solution. 1.7335 g of MnO powder was accurately weighed and then added to the pyrophosphoric acid solution, and the mixture was stirred to give a pink solution. 2.1734 g of MnO₂ was added to the pink solution, and the resulting mixture was incubated at 50° C. for 20 min until the solution turned dark purplish red. The solution was then filtered to remove the residue. The dark purplish red solution was transferred to a flask, heated to 100° C., and incubated for 6 h to give a cyan solution. The precipitate was separated by filtration, washed, and dried to give a pale green powder (5.9759 g).

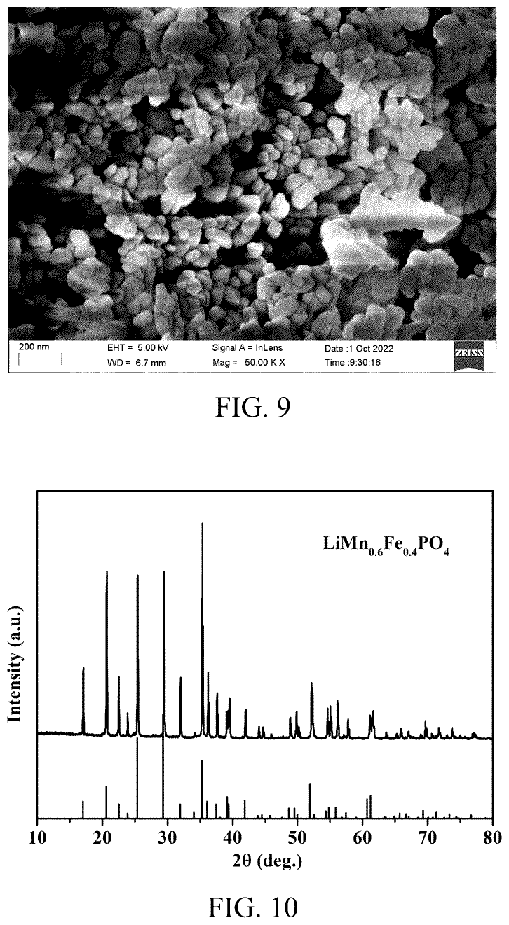

The resulting pale green powder was subjected to X-ray diffraction to give an XRD pattern shown in FIG. 8, suggesting that the product was MnPO₄·H₂O. The resulting pale green manganese phosphate powder was detected by SEM to give a scanning electron microscope image shown in FIG. 9. It can be seen from the figure that the powder particles are nanoparticles.

### Example 3-3: MnO—MnO₂—H₄P₂O₇

55.62 g of pyrophosphoric acid solid was accurately weighed and dissolved in 50 mL of deionized water to form an aqueous pyrophosphoric acid solution. 1.7335 g of MnO and 2.1734 g of MnO₂ were accurately weighed and then added to the pyrophosphoric acid solution, and the mixture was stirred until the solution turned dark purplish red. The solution was then stirred at room temperature for 40 min. The mixture was filtered to remove the residues. The dark purplish red solution was transferred to a flask, heated to 90° C., and then incubated. A gray substance was generated in the solution first, and a pale green product was obtained after 6 h. The product did not precipitate naturally. The product was centrifuged, washed, and dried to give a powder (5.6574 g). The XRD pattern shows that the product was MnPO₄·H₂O.

### Example 3-4: MnO—MnO₂—H₄P₂O₇

100.63 g of pyrophosphoric acid solid was accurately weighed and dissolved in 50 mL of deionized water to form an aqueous pyrophosphoric acid solution. 1.7335 g of MnO powder was accurately weighed and then added to the pyrophosphoric acid solution, and the mixture was stirred to give a pink solution. 2.1733 g of MnO₂ was added to the pink solution, and the resulting mixture was warmed to 50° C. and incubated for 20 min until the solution turned dark purplish red. The solution was filtered in vacuum to give a purplish red filtrate and a black residue. The dark purplish red solution was transferred to a flask, heated to 100° C., and incubated for 6 h to give a cyan precipitate. The precipitate was separated by filtration, washed, and dried to give a pale green powder (6.0642 g). The XRD pattern shows that the product was MnPO₄·H₂O.

### Example 3-5: Mn₃O₄+H₄P₂O₇

62.74 g of pyrophosphoric acid solid was accurately weighed and dissolved in 50 mL of deionized water to form an aqueous pyrophosphoric acid solution. 3.8138 g of Mn₃O₄ powder was accurately weighed and then added to the pyrophosphoric acid solution, and the mixture was stirred. The solution was warmed to 50° C. and incubated for 20 min until the solution turned purplish red. The mixture was filtered to remove the residues. The dark purplish red solution was transferred to a flask, heated to 100° C., and incubated for 6 h to give a cyan precipitate. The precipitate was filtered, washed, and dried to give a cyan powder (5.3392 g). The XRD pattern shows that the product was MnPO₄·H₂O.

### Example 3-6: Mn₃O₄+MnO₂+H₄P₂O₇

62.74 g of pyrophosphoric acid solid was accurately weighed and dissolved in 50 mL of deionized water to form an aqueous pyrophosphoric acid solution. 3.8133 g of Mn₃O₄ powder was accurately weighed and then added to the pyrophosphoric acid solution, and the mixture was stirred. 1.4489 g of MnO₂ powder was accurately weighed and added to the pyrophosphoric acid solution, and the mixture was stirred. The solution was warmed to 50° C. and incubated for 20 min until the solution turned purplish red. The mixture was filtered to remove the residues. The dark purplish red solution was transferred to a flask, heated to 100° C., and incubated for 6 h to give a cyan precipitate. The precipitate was filtered, washed, and dried to give a cyan powder (8.3261 g). The XRD pattern shows that the product was MnPO₄·H₂O.

### Example 3-7: Preparation of Lithium Manganese Iron Phosphate LiMn_{0.6}Fe_{0.4}PO₄

0.5032 g of the MnPO₄·H₂O powder prepared in Example 3-1, 0.3737 g of FePO₄·2H₂O powder, 0.2203 g of LiOH·H₂O powder, and 0.25 g of polyethylene glycol were weighed. The four powders were mixed uniformly and then transferred to a tube furnace. Nitrogen was introduced, and the mixture was calcined at 750° C. for 12 h. After the reaction was completed, the mixture was naturally cooled to room temperature to give a LiMn_{0.6}Fe_{0.4}PO₄/C material. The XRD pattern of the prepared lithium manganese iron phosphate powder, i.e., the XRD pattern of LiMn_{0.6}Fe_{0.4}PO₄/C, is shown in FIG. 10.

The embodiments of the present disclosure have been described above. However, the present disclosure is not limited to these embodiments. Any modification, equivalent, improvement, and the like made without departing from the spirit and principle of the present disclosure shall fall within the claimed scope of the present disclosure.

1. A method for preparing manganese phosphate, characterized in that the method comprises: contacting, in a solution at pH<7, pyrophosphate ion with trivalent manganese ion to form a manganese pyrophosphate complex solution, and decomplexing to give a manganese phosphate precipitate.

2. The method according to claim 1, characterized in that the method comprises: reacting pyrophosphoric acid with a trivalent manganese-containing oxide to give the manganese pyrophosphate complex solution, and decomplexing to give the manganese phosphate precipitate, wherein the trivalent manganese-containing oxide is selected from dimanganese trioxide.

3. The method according to claim 1, characterized in that the method comprises: reacting pyrophosphoric acid, an oxidant, and a divalent manganese-containing oxide to give the manganese pyrophosphate complex solution, and decomplexing to give the manganese phosphate precipitate, wherein the divalent manganese-containing oxide is manganese monoxide or trimanganese tetraoxide; the oxidant is selected from MnO₂, Mn₂O₆, manganous acid, manganous anhydride, manganic acid, manganic anhydride, HMnO₄, permanganic anhydride, an alkali metal or alkaline earth metal manganate salt, and an alkali metal or alkaline earth metal permanganate salt, and the oxidant is preferably MnO₂ or potassium permanganate.

4. The method according to claim 1, characterized in that the method comprises: reacting pyrophosphoric acid, a reductant, and a tetravalent manganese-containing oxide to give the manganese pyrophosphate complex solution, and decomplexing to give the manganese phosphate precipitate, wherein the tetravalent manganese-containing oxide is selected from one of manganese dioxide and trimanganese tetraoxide, and a combination thereof; the reductant is selected from an inorganic reductant and/or an organic reductant with a standard electrode potential value of lower than +0.77.

5. The method according to claim 1, characterized in that the method comprises, before the decomplexing step: removing unreacted solids by solid-liquid separation, wherein the unreacted solids comprise impurities and/or the unreacted oxide of manganese.

6. The method according to claim 4, characterized in that the reductant is one of hydrogen peroxide, a ferrous ion-containing salt, a stannous ion-containing salt, a cuprous ion-containing salt, a C₁₋₈ acid, a C₁₋₈ alcohol, a C₁₋₈ aldehyde, a C₃₋₈ ketone, a monosaccharide, a disaccharide or an oligosaccharide, or a combination thereof;
preferably, the reductant is selected from one of hydrogen peroxide, formaldehyde, formic acid, oxalic acid, citric acid, ascorbic acid, a ferrous inorganic acid salt, a ferrous organic acid salt, a stannous inorganic acid salt and a stannous organic acid salt, and a combination thereof.

7. The method according to claim 2, characterized in that the method comprises:
step S1: preparation of the complex solution: controlling the phosphorus-to-manganese ratio in starting materials at no less than 3:1 and mixing the oxide of trivalent manganese with a pyrophosphoric acid solution, or mixing the tetravalent manganese-containing oxide, the reductant, and a pyrophosphoric acid solution in a proper ratio, or mixing a divalent manganese-containing oxide, the oxidant, and a pyrophosphoric acid solution in a proper ratio, and reacting to give the complex solution; and
step S2: decomplexation of the complex solution: heating the obtained complex solution, or adding a proper amount of water before or during the heating as required, or optionally, pressurizing during the heating and/or water addition step(s) with a pressure range of 0.15 Mpa to 2 Mpa, so as to give the manganese phosphate precipitate, wherein preferably, in step S1, the reaction temperature is controlled at 0° C. to 70° C., more preferably, at 20° C. to 55° C.;
preferably, in step S2, the heating temperature is controlled at 50° C.-180° C., more preferably, at 70° C. to 120° C.;
preferably, the molar ratio of the reductant to tetravalent manganese is (0.1-10):1, more preferably (0.3-3):1; and/or
preferably, the molar ratio of the oxidant to the oxide of divalent manganese is 0.7-1.3 folds the theoretical value.

8. The method according to claim 7, characterized in that the phosphorus-to-manganese ratio is controlled at 4:1-16:1;
preferably, the proper amount of water in step S2 is an amount by volume of water 0.01-20 folds the volume of the solution to be decomplexed, on the basis of the volume of the solution to be decomplexed being 1.

9. The method according to claim 7, characterized in that in step S2, the decomplexation is performed only by heating, with the temperature controlled at 70° C. to 120° C.

10. The method according to claim 7, characterized in that the method comprises, as required, after step S1 and before step S2: step S11, impurity removal: performing solid-liquid separation to give the complex solution.

11. The method according to claim 7, characterized in that the method comprises, after the precipitate is obtained in step S2: performing solid-liquid separation to give manganese phosphate monohydrate.

12. The method according to claim 11, characterized in that phosphoric acid contained in the mother liquor obtained in step S2 is recovered.

13. A method for preparing carbon-coated lithium manganese iron phosphate, characterized in that the method comprises: mixing manganese phosphate, ferric phosphate, lithium hydroxide, and a carbon source material, and calcining at 500-1000° C. to give carbon-coated lithium manganese iron phosphate, wherein the molar ratio of lithium to manganese and iron is controlled at [Li:(Mn+Fe)]=(1.05-1.10):1, and the molar ratio of manganese to iron (Mn:Fe) is controlled at (0.01-0.99):(0.99-0.01); the manganese phosphate is prepared by the method according to claim 1.

14. A battery, characterized in that the carbon-coated lithium manganese iron phosphate prepared by the method according to claim 13 is used as the positive electrode material.

15. The method according to claim 3, characterized in that the method comprises:
step S1: preparation of the complex solution: controlling the phosphorus-to-manganese ratio in starting materials at no less than 3:1 and mixing the oxide of trivalent manganese with a pyrophosphoric acid solution, or mixing the tetravalent manganese-containing oxide, the reductant, and a pyrophosphoric acid solution in a proper ratio, or mixing a divalent manganese-containing oxide, the oxidant, and a pyrophosphoric acid solution in a proper ratio, and reacting to give the complex solution; and
step S2: decomplexation of the complex solution: heating the obtained complex solution, or adding a proper amount of water before or during the heating as required, or optionally, pressurizing during the heating and/or water addition step(s) with a pressure range of 0.15 Mpa to 2 Mpa, so as to give the manganese phosphate precipitate, wherein
preferably, in step S1, the reaction temperature is controlled at 0° C. to 70° C., more preferably, at 20° C. to 55° C.;
preferably, in step S2, the heating temperature is controlled at 50° C.-180° C., more preferably, at 70° C. to 120° C.;
preferably, the molar ratio of the reductant to tetravalent manganese is (0.1-10):1, more preferably (0.3-3):1; and/or
preferably, the molar ratio of the oxidant to the oxide of divalent manganese is 0.7-1.3 folds the theoretical value.

16. The method according to claim 4, characterized in that the method comprises:
step S1: preparation of the complex solution: controlling the phosphorus-to-manganese ratio in starting materials at no less than 3:1 and mixing the oxide of trivalent manganese with a pyrophosphoric acid solution, or mixing the tetravalent manganese-containing oxide, the reductant, and a pyrophosphoric acid solution in a proper ratio, or mixing a divalent manganese-containing oxide, the oxidant, and a pyrophosphoric acid solution in a proper ratio, and reacting to give the complex solution; and
step S2: decomplexation of the complex solution: heating the obtained complex solution, or adding a proper amount of water before or during the heating as required, or optionally, pressurizing during the heating and/or water addition step(s) with a pressure range of 0.15 Mpa to 2 Mpa, so as to give the manganese phosphate precipitate, wherein
preferably, in step S1, the reaction temperature is controlled at 0° C. to 70° C., more preferably, at 20° C. to 55° C.;
preferably, in step S2, the heating temperature is controlled at 50° C.-180° C., more preferably, at 70° C. to 120° C.;
preferably, the molar ratio of the reductant to tetravalent manganese is (0.1-10):1, more preferably (0.3-3):1; and/or
preferably, the molar ratio of the oxidant to the oxide of divalent manganese is 0.7-1.3 folds the theoretical value.
